(19) United States
(12) Patent Application Publication
(10) Pub. No.: US 2013/0334143 A1
(43) Pub. Date: Dec. 19, 2013

(54) APPARATUS AND METHOD FOR PHOSPHOROUS REMOVAL FROM WASTE WATER USING DOLOMITE

(71) Applicants: Kyung Guen SONG, Seoul (KR); Byung Ha LEE, Daegu (KR); Ho Young CHA, Seoul (KR)

(72) Inventors: Kyung Guen SONG, Seoul (KR); Byung Ha LEE, Daegu (KR); Ho Young CHA, Seoul (KR)

(73) Assignee: KOREA INSTITUTE OF SCIENCE AND TECHNOLOGY, Seoul (KR)

(21) Appl. No.: 13/593,191

(22) Filed: Aug. 23, 2012

(30) Foreign Application Priority Data
Jun. 14, 2012 (KR) 10-2012-0063682

(51) Int. Cl. C02F 1/52; B01D 21/02; B01D 21/01

(52) U.S. Cl. 210/710; 210/208; 210/202; 210/723

(57) ABSTRACT

The present disclosure provides apparatus and method for phosphorous removal using dolomite by mixing an inorganic coagulant and dolomite together to improve the phosphorous removal efficiency and controlling pH, which has been lowered due to the use of the inorganic coagulant, close to the neutral by means of dolomite to improve the economic feasibility and minimize an additional neutralizing process.

### CROSS-REFERENCE TO RELATED APPLICATION

This application claims priority to Korean Patent Application No. 10-2012-0063682, filed on Jun. 14, 2012, and all the benefits accruing therefrom under 35 U.S.C. §119, the contents of which in its entirety are herein incorporated by reference.

### BACKGROUND

1. Field

The present disclosure relates to apparatus and method for phosphorous removal using dolomite, and more particularly, to apparatus and method for phosphorous removal using dolomite by mixing an inorganic coagulant and dolomite together to improve the phosphorous removal efficiency and controlling pH, which has been lowered due to the use of the inorganic coagulant, close to the neutral by means of dolomite to improve the economic feasibility and minimize an additional neutralizing process.

2. Description of the Related Art

Water is an essential element required for the existence of all living organisms and an indispensable element for the living of human beings. However, industrial development has caused serious contamination of water. The contaminated water destroys the aquatic ecosystem and contaminates soil, underground water or the like, thereby threatening the right of live of the human being.

In these days, most sewage treatment plants remove phosphorous (P) by means of biological treatment, which is however not stable due to the lack of carbon source and the inappropriate maintenance and so can hardly satisfy the water quality standards which are being reinforced. Therefore, various studies are required about chemical treatment of phosphorous (P) such as reinforcement of a chemical injecting facility, rather than the biological treatment.

A most universal chemical treatment method is a coagulation method using a coagulant, which however hardly satisfies the reinforced regulations if the system is not operated efficiently and also has a problem of bad economic feasibility due to the excessive use of a coagulant. An example of the apparatus for phosphorous removal using an inorganic coagulant is disclosed in Korean Patent Registration No. 1017055.

### RELATED LITERATURES

### Patent Literature

(Patent Literature 1) Korean Patent Registration No. 1017055

### SUMMARY

The present disclosure is directed to providing apparatus and method for phosphorous removal using dolomite by mixing an inorganic coagulant and dolomite together to improve the phosphorous removal efficiency and controlling pH, which has been lowered due to the use of the inorganic coagulant, close to the neutral by means of dolomite to improve the economic feasibility and minimize an additional neutralizing process.

In one aspect, there is provided an apparatus for phosphorous removal using dolomite, which includes: a rapid mixing tank for rapidly stirring an inorganic coagulant and dolomite together with source water to form flocs by reacting phosphate ions (−) contained in the source water and metal ions of the inorganic coagulant and to form coagulation nuclei composed of Ca and Mg precipitates or Ca, Mg and Fe precipitates of the dolomite; a slow mixing tank for slowly stirring the source water supplied from the rapid mixing tank so that the flocs formed in the rapid mixing tank and the coagulation nuclei formed by components of the dolomite grow; a settling tank for gravitationally settling the flocs grown by the source water supplied from the slow mixing tank to be separated into treated water and sludge; an inorganic coagulant injecting device for supplying the inorganic coagulant to the rapid mixing tank; and a dolomite injecting device for supplying the dolomite to the rapid mixing tank.

In another aspect, there is also provided an apparatus for phosphorous removal using dolomite, which includes: an inline mixer for moving an inorganic coagulant and dolomite in an inline pattern to be mixed with source water; a rapid mixing tank for slowly stirring the mixture of the inorganic coagulant, the dolomite and the source water to form flocs by reacting phosphate ions (−) contained in the source water and metal ions of the inorganic coagulant and to form coagulation nuclei composed of Ca and Mg precipitates or Ca, Mg and Fe precipitates of the dolomite; a slow mixing tank for slowly stirring the source water supplied from the rapid mixing tank so that the flocs formed in the rapid mixing tank and the coagulation nuclei formed by components of the dolomite grow; a settling tank for gravitationally settling the flocs grown by the source water supplied from the slow mixing tank to be separated into treated water and sludge; an inorganic coagulant injecting device for supplying the inorganic coagulant to the inline mixer; and a dolomite injecting device for supplying the dolomite to the inline mixer.

In another aspect, there is also provided an apparatus for phosphorous removal using dolomite, which includes: a rapid mixing tank for rapidly stirring an inorganic coagulant and dolomite together with source water to form flocs by reacting phosphate ions (−) contained in the source water and metal ions of the inorganic coagulant and to form coagulation nuclei composed of Ca and Mg precipitates or Ca, Mg and Fe precipitates of the dolomite; a slow mixing tank for slowly stirring the source water supplied from the rapid mixing tank so that the flocs formed in the rapid mixing tank and the coagulation nuclei formed by components of the dolomite grow; a CAP system for adsorbing the flocs, grown by the source water supplied from the slow mixing tank, to a coil-type filter so that treated water is separated therefrom; an inorganic coagulant injecting device for supplying the inorganic coagulant to the rapid mixing tank; and a dolomite injecting device for supplying the dolomite to the rapid mixing tank.

The dolomite may play a role of an alkaline chemical to raise pH of the source water, which has been lowered by the inorganic coagulant, so that the source water is neutralized, and the dolomite may be fired at a temperature of 800 to 900° C. so that CO₂ components are removed.

The inorganic coagulant may be a low basicity inorganic coagulant or a high basicity inorganic coagulant, the low basicity inorganic coagulant may be any one selected from the group consisting of aluminum sulfate, ferric chloride, ferric aluminum, and magnesium chloride, and the high basicity inorganic coagulant may be any one selected from the group consisting of polyaluminum chloride, polyaluminum chloride silicate, polyaluminum hydroxy chloro sulfate, polyaluminum chloride silicate, polyaluminum chloride sulfate silicate, and polyaluminum sulfate silicate.

In another aspect, there is also provided a method for phosphorous removal using dolomite, which includes: stirring an inorganic coagulant and dolomite together with source water to form flocs by reacting phosphate ions (−) contained in the source water and metal ions (+) of the inorganic coagulant, to form coagulation nuclei composed of Ca and Mg precipitates or Ca, Mg and Fe precipitates of the dolomite, and to allow the dolomite to raise pH of the source water, which has been lowered by the inorganic coagulant, so that the source water is neutralized; and after the inorganic coagulant, the dolomite, and the source water are stirred, separating treated water therefrom by gravitationally settling the grown flocks or adsorbing the flocks to a filter and removing the flocks.

The apparatus and method for phosphorous removal using dolomite according to the present disclosure give the following effects.

The dolomite injected together with an inorganic coagulant may improve the phosphorous removal efficiency and suppress the decrease of pH of the source water, which are roles of the coagulant aid and an alkaline chemical. Therefore, it is possible to reduce the amount of inorganic coagulant used and minimize the process for neutralizing the source water.

### BRIEF DESCRIPTION OF THE DRAWINGS

FIG. 1 is a diagram showing an apparatus for phosphorous removal using dolomite according to a first embodiment of the present disclosure;

FIG. 2 is a diagram showing an apparatus for phosphorous removal using dolomite according to a second embodiment of the present disclosure; and

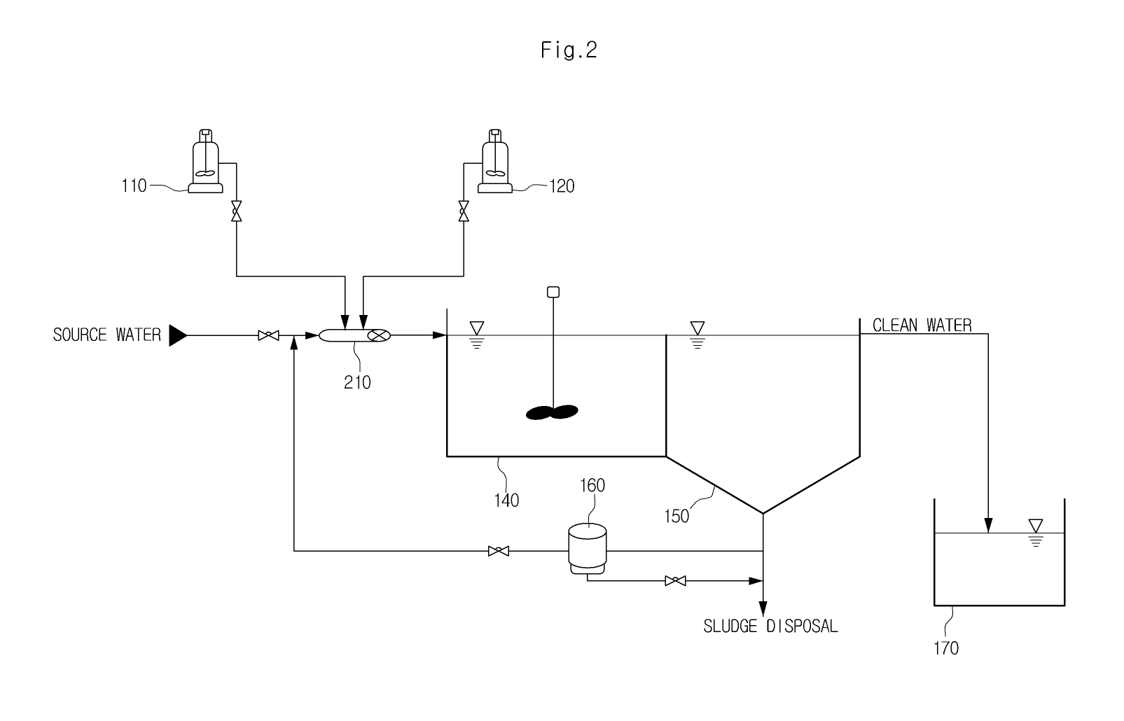

FIG. 3 is a diagram showing an apparatus for phosphorous removal using dolomite according to a third embodiment of the present disclosure.

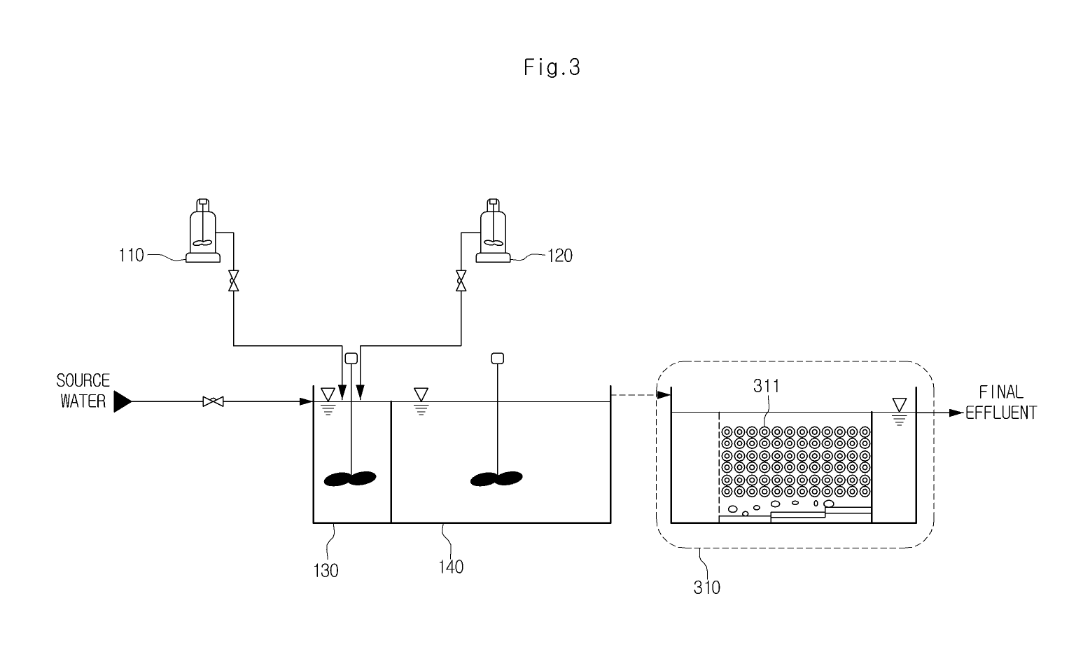

[Detailed Description of Main Elements]

| | |
|---|---|
| 110: inorganic coagulant injecting device | 120: dolomite injecting device |
| 130: rapid mixing tank | 140: slow mixing tank |
| 150: settling tank | 160: sludge thickener |
| 170: final effluent tank | 210: inline mixer |
| 310: CAP system | 311: coil-type filter |

### DETAILED DESCRIPTION

The present disclosure is characterized in that an inorganic coagulant and dolomite are used to remove phosphorous contained in sewage. The inorganic coagulant plays a role of performing a direct coagulation reaction with phosphate ions to form floc, and the dolomite plays a role of a coagulant aid and an alkaline chemical. The dolomite adsorbs phosphate ions and its main components, namely Ca and Mg or Ca, Mg and Fe, form precipitates to play a role of coagulation nuclei and functions as a coagulant aid, and simultaneously plays a role of an alkaline chemical which controls pH of the source water close to the neutral due to the alkaline characteristic of the dolomite. In other words, by mixing the inorganic coagulant and the dolomite, it is possible to improve the phosphorous removal efficiency and suppress the drop of pH of the source water.

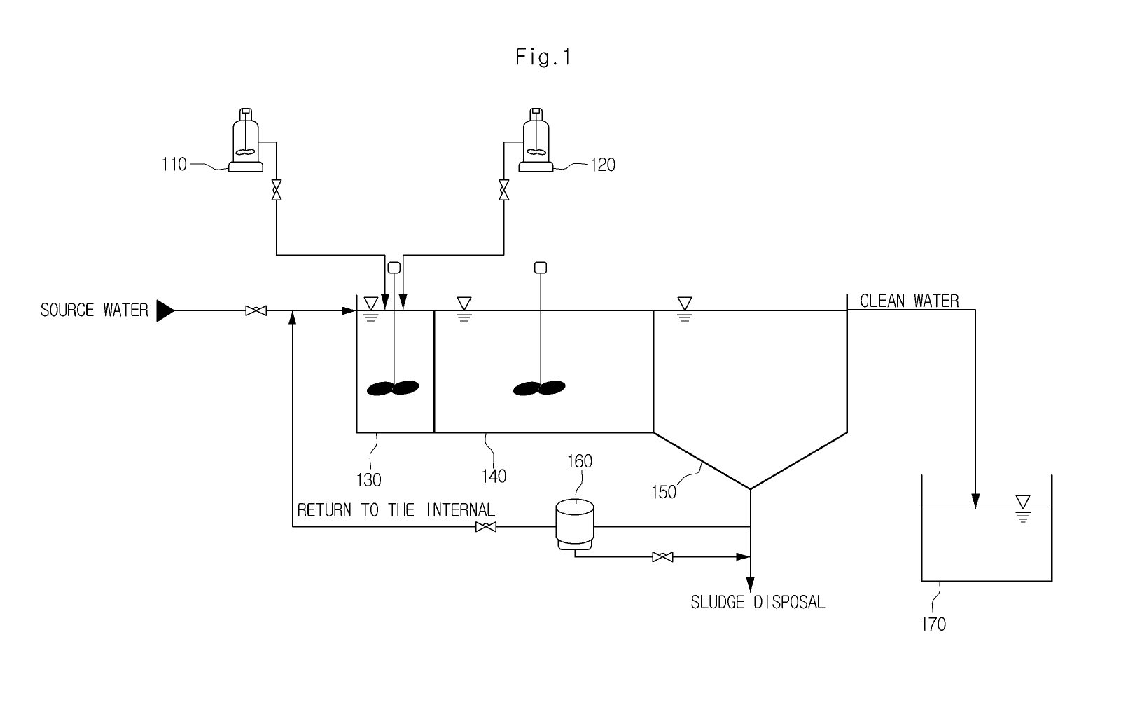

Hereinafter, the apparatus and method for phosphorous removal using dolomite according to an embodiment of the present disclosure will be described in detail. FIG. 1 is a diagram showing an apparatus for phosphorous removal using dolomite according to a first embodiment of the present disclosure.

Referring to FIG. 1, the apparatus for phosphorous removal according to the present disclosure is configured to include a rapid mixing tank 130, a slow mixing tank 140, a settling tank 150, an inorganic coagulant injecting device 110 and a dolomite injecting device 120.

The rapid mixing tank 130 is a device for rapidly stirring an inorganic coagulant and dolomite together with source water, and due to the rapid stirring, phosphate ions (−) contained in the source water react with metal ions (+) of the inorganic coagulant to form flocs, and the phosphate ions remaining in the source water are adsorbed to the dolomite so that the concentration of phosphate ions in the water decreases. Simultaneously, the main components of the dolomite, namely Ca and Mg or Ca, Mg and Fe, form precipitates, and these precipitates serve as coagulation nuclei to be coupled with surrounding fine flocs. The dolomite is supplied through the dolomite injecting device 120, and the inorganic coagulant is supplied through the inorganic coagulant injecting device 110.

The dolomite is obtained by firing dolomite gemstone at a temperature of 800 to 900° C. for 8 hours. Due to the firing, the dolomite is composed of CaO and MgO or composed of CaO, MgO and FeO, and during the rapid stirring, Ca and Mg of dolomite or Ca, Mg and Fe of the dolomite form precipitates. In addition, the fired dolomite has an increased specific surface which reinforces the adsorbing property of phosphate ions. The dolomite may have a particle diameter less than 45 μm for good reactivity.

In addition, the inorganic coagulant may employ a low basicity inorganic coagulant or a high basicity inorganic coagulant. The low basicity inorganic coagulant may employ is any one of aluminum sulfate, ferric chloride, ferric aluminum, and magnesium chloride, and the high basicity inorganic coagulant may employ any one of polyaluminum chloride, polyaluminum chloride silicate, polyaluminum hydroxy chloro sulfate, polyaluminum chloride silicate, polyaluminum chloride sulfate silicate, and polyaluminum sulfate silicate.

The slow mixing tank 140 plays a role of slow stirring so that the flocs formed in the rapid mixing tank 130 and the coagulation nuclei formed by components of the dolomite are coupled more greatly to grow as easily-precipitated flocs, and by doing so, the size and density of flocs increase and the settling efficiency in the following settling tank 150 is improved.

The settling tank 150 plays a role of gravitationally settling the flocs, grown by the source water supplied from the slow mixing tank 140, to be separated into treated water and sludge, and the treated water separated by the settling tank 150 is discharged through a final effluent tank 170. In addition, a part of the sludge separated through the settling tank 150 is returned into the rapid mixing tank 130 through a sludge thickener 160. The sludge thickened by the sludge thickener 160 is wasted, and high-grade water is supplied to the rapid mixing tank 130.

Heretofore, the apparatus for phosphorous removal using dolomite according to a first embodiment of the present disclosure has been described. In the configuration of the first embodiment, some components may be modified. In detail, in the configuration of the first embodiment, the rapid mixing tank 130 may be replaced with an inline mixer 210 (a second embodiment). The inline mixer 210 is a device for moving the inorganic coagulant and the dolomite, respectively supplied from the inorganic coagulant injecting device 110 and the dolomite injecting device 120, in an inline pattern to be mixed with source water, and the inorganic coagulant, the dolomite, and the source water mixed by the inline mixer 210 are supplied to the slow mixing tank 140. The mixture of the inorganic coagulant, the dolomite, and the source water supplied to the slow mixing tank 140 reacts with phosphate ions in the source water to form flocs and serve as precipitates and coagulation nuclei.

As a modification of the first embodiment, the settling tank 150 of the first embodiment may be replaced with a combined and polishing (CAS) system (a third embodiment). The CAP system 310 is a device having a coil-type filter 311 provided in the reaction tank, and the flocs and coagulations contained in the source water supplied from the slow mixing tank 140 are adsorbed to the coil-type filter, through which treated water is separated.

Heretofore, the apparatus and method for phosphorous removal using dolomite according to an embodiment of the present disclosure have been described. Hereinafter, the present disclosure will be described in more detail by means of experimental examples.

### <Experiment Method>

The apparatus of the first embodiment was used. From the results obtained in several experiments, the apparatus exhibited optimal efficiency when rapid stirring of 250 rpm was performed for 1 minute, slow stirring of 60 rpm was performed for 15 minutes and precipitation time was 30 minute. The above conditions were applied to all experiments below.

The experiments were performed to a case where dolomite was used solely, a case where polyaluminum chloride serving as the inorganic coagulant was used solely, and a case where dolomite and polyaluminum chloride were mixed, and for experiment, total phosphorous (T-P), dissoluble phosphorous (PO₄³⁻P), suspended solid (SS), and pH were analyzed.

<Experimental Result 1: Dolomite was Used Solely>

The results of the coagulation experiment where dolomite fired at 850° C. for 8 hours to increase a specific surface area was used solely are shown in Table 1 below.

TABLE 1
Experimental Result for the case where dolomite was used solely
dolomite was solely used

| | T-P (mg/L) | PO₄³⁻-P (mg/L) | SS (mg/L) | pH |
|---|---|---|---|---|
| source water | 3.73 | 3.16 | 17.2 | 7.05 |
| dolomite | 3.46 | 2.98 | 8 | 7.84 |
| (10 mg/L) | | | | |
| dolomite | 3.21 | 2.97 | 6.8 | 7.96 |
| (25 mg/L) | | | | |

As shown in Table 1, the source water of the sewage treatment plant exhibited T-P of 3.73 mgP/L, PO₄³⁻P of 3.16 mgP/L, SS of 17.2 mg/L, and pH of 7.05. When the amount of dolomite injected was 10 mg/L and 25 mg/L, T-P was 3.46 mgP/L and 3.21 mgP/L, PO₄³⁻P was 2.98 mgP/L and 2.97 mgP/L, and SS was 8 mg/L and 6.8 mg/L. It can be understood that the coagulation and adsorption of phosphorous occurs due to main components of the fired dolomite, namely CaO, FeO or the like, and the precipitation efficiency is improved as the amount of dolomite injected increases.

<Experimental Result 2: Polyaluminum chloride was Used Solely>

The results of the coagulation experiment where the amount of injected polyaluminum chloride with Al₂O₃ concentration of 17% was changed are shown in Table 2 below.

TABLE 2
Experimental Result for the case where polyaluminum chloride was used
solely
polyaluminum chloride (PAC) was used solely

| | T-P (mg/L) | PO₄³⁻-P (mg/L) | SS (mg/L) | pH |
|---|---|---|---|---|
| source water | 3.73 | 3.16 | 17.2 | 7.05 |
| PAC 5 mgAl/L | 1.92 | 0.06 | 5.6 | 6.65 |
| PAC 10 mgAl/L | 0.5 | 0.01 | 1.6 | 6.11 |
| PAC 15 mgAl/L | 1.61 | 0.26 | 34.8 | 5.35 |
| PAC 20 mgAl/L | 2.15 | 1.79 | 36.0 | 4.63 |

As shown in Table 2, when the amount of injected polyaluminum chloride was changed to 5, 10, 15, and 20 mgAl/L, respectively, T-P was 1.92, 0.5, 1.61, and 2.15 mgP/L, respectively. PO₄³⁻P was 0.06, 0.01, 0.26, and 1.79 mgP/L, respectively, and SS was 5.6, 1.6, 34.8, and 36.0 mg/L, respectively. In addition, pH was 6.65, 6.11, 5.35, and 4.63, respectively. It can be understood that the coagulation is performed better as the amount of injected polyaluminum chloride increases, but if polyaluminum chloride is injected over a certain concentration, pH deviates from a suitable coagulation pH range so that the coagulation is not performed well. However, when the amount of injected polyaluminum chloride (PAC) was 10 mgAl/L where the coagulation was performed in a best way, T-P was 0.5 mgP/L, which does not satisfy the effluence quality standard of 0.2 mgP/L. As described above, it can be understood that the effluence quality standard cannot be stably satisfied if the coagulant is used solely.

<Experimental Result 3: Dolomite (10 mg/L) and Polyaluminum Chloride were Mixed>

The results of the coagulation experiment where the amount of injected polyaluminum chloride with Al₂O₃ concentration of 17% was changed in a state where the amount of fired dolomite injected is fixed to be 10 mg/L are shown in Table 3 below.

TABLE 3
Experimental Result for the case where dolomite (10 mg/L) and
polyaluminum chloride were mixed
dolomite has a fixed amount of 10 mg/L, and polyaluminum
chloride (PAC) has a variable injected amount

| | T-P (mg/L) | PO₄³⁻-P (mg/L) | SS (mg/L) | pH |
|---|---|---|---|---|
| source water | 3.73 | 3.16 | 17.2 | 7.05 |
| PAC 5 mgAl/L | 1.71 | 1.25 | 5.6 | 7.35 |
| PAC 10 mgAl/L | 0.41 | 0.12 | 3.6 | 7.03 |
| PAC 15 mgAl/L | 0.05 | 0 | 0 | 6.75 |
| PAC 20 mgAl/L | 0.2 | 0 | 0.4 | 6.55 |

As shown in Table 3, when the amount of polyaluminum chloride was changed to 5, 10, 15, and 20 mgAl/L, respectively, in a state where the amount of fired dolomite injected was fixed to be 10 mg/L, T-P was 1.71, 041, 0.05, and 0.2 mgP/L, respectively. PO₄³⁻P was 1.25, 0.12, 0, and 0 mgP/L, respectively, and SS was 5.6, 3.6, 0, and 0.4 mg/L, respectively. In addition, pH was 7.35, 7.03, 6.75, and 6.55, respectively. Since the dolomite plays a role of an alkali aid which was a problem at the case where polyaluminum chloride is used solely, it can be understood from SS that a suitable coagulation pH range is satisfied and the precipitatability is improved over a suitable injected amount.

<Experimental Result 4: Dolomite (25 mg/L) and Polyaluminum Chloride were Mixed>

The results of the coagulation experiment where the amount of injected polyaluminum chloride with Al₂O₃ concentration of 17% was changed in a state where the amount of fired dolomite injected is fixed to be 25 mg/L are shown in Table 4 below.

TABLE 4
Experimental Result for the case where dolomite (25 mg/L) and
polyaluminum chloride were mixed
dolomite has a fixed amount of 25 mg/L, and polyaluminum
chloride (PAC) has a variable injected amount

| | T-P (mg/L) | PO₄³⁻-P (mg/L) | SS (mg/L) | pH |
|---|---|---|---|---|
| source water | 3.73 | 3.16 | 17.2 | 7.05 |
| PAC 5 mgAl/L | 1.60 | 1.25 | 4.4 | 7.58 |
| PAC 10 mgAl/L | 0.38 | 0.21 | 2.4 | 7.31 |
| PAC 15 mgAl/L | 0.09 | 0.03 | 1.6 | 7.04 |
| PAC 20 mgAl/L | 0.03 | 0.01 | 1.6 | 6.86 |

As shown in Table 4, when the amount of polyaluminum chloride was changed to 5, 10, 15, and 20 mgAl/L, respectively, in a state where the amount of fired dolomite injected was fixed to be 25 mg/L, T-P was 1.60, 038, 0.09, and 0.03 mgP/L, respectively. PO₄³⁻P was 1.25, 0.21, 0.03, and 0.01 mgP/L, respectively, and SS was 4.4, 2.4, 1.6, and 1.6 mg/L, respectively. In addition, pH was 7.58, 7.31, 7.04, and 6.86, respectively. From these results, it can be understood that the effluence quality standard can be stably satisfied when the dolomite has an injected amount of 25 mg/L and the polyaluminum chloride has an injected amount of 15 mgAl/L or above.

As a result, it can be understood that the coagulation and precipitation are performed in a best way when the injected amounts of dolomite and polyaluminum chloride (PAC) are over suitable levels. It can be judged that the inorganic coagulant, polyaluminum chloride, was well coagulated with respect to dissoluble phosphorous, the fired dolomite supplemented alkali to play a role of a pH neutralizing agent, and the precipitation efficiency was improved by adsorbing coagulated fine flocks or increasing the size of coagulated flocks.

From the above results, it can be understood that phosphorous is removed more efficiently by using the inorganic coagulant and the coagulant aid together according to the present disclosure, in comparison to an existing sole-use coagulation method. In addition, when the same amount of coagulating agent is used, it can be found that phosphorous is removed more efficiently if dolomite serving as a coagulant aid is used together, in comparison to the case where the coagulating agent is used solely. In other words, when treating the same amount of phosphorous, the amount of inorganic coagulant injected may be reduced if the inorganic coagulant and the coagulant aid are used together.

What is claimed is:

1. An apparatus for phosphorous removal using dolomite, comprising:
a rapid mixing tank for rapidly stirring an inorganic coagulant and dolomite together with source water to form flocs by reacting phosphate ions (−) contained in the source water and metal ions of the inorganic coagulant and to form coagulation nuclei composed of Ca and Mg precipitates or Ca, Mg and Fe precipitates of the dolomite;
a slow mixing tank for slowly stirring the source water supplied from the rapid mixing tank so that the flocs formed in the rapid mixing tank and the coagulation nuclei formed by components of the dolomite grow;
a settling tank for gravitationally settling the flocs grown by the source water supplied from the slow mixing tank to be separated into treated water and sludge;
an inorganic coagulant injecting device for supplying the inorganic coagulant to the rapid mixing tank; and
a dolomite injecting device for supplying the dolomite to the rapid mixing tank.

2. An apparatus for phosphorous removal using dolomite, comprising:
an inline mixer for moving an inorganic coagulant and dolomite in an inline pattern to be mixed with source water;
a rapid mixing tank for slowly stirring the mixture of the inorganic coagulant, the dolomite and the source water to form flocs by reacting phosphate ions (−) contained in the source water and metal ions of the inorganic coagulant and to form coagulation nuclei composed of Ca and Mg precipitates or Ca, Mg and Fe precipitates of the dolomite;
a slow mixing tank for slowly stirring the source water supplied from the rapid mixing tank so that the flocs formed in the rapid mixing tank and the coagulation nuclei formed by components of the dolomite grow;
a settling tank for gravitationally settling the flocs grown by the source water supplied from the slow mixing tank to be separated into treated water and sludge;
an inorganic coagulant injecting device for supplying the inorganic coagulant to the inline mixer; and
a dolomite injecting device for supplying the dolomite to the inline mixer.

3. An apparatus for phosphorous removal using dolomite, comprising:
a rapid mixing tank for rapidly stirring an inorganic coagulant and dolomite together with source water to form flocs by reacting phosphate ions (−) contained in the source water and metal ions of the inorganic coagulant and to form coagulation nuclei composed of Ca and Mg precipitates or Ca, Mg and Fe precipitates of the dolomite;
a slow mixing tank for slowly stirring the source water supplied from the rapid mixing tank so that the flocs formed in the rapid mixing tank and the coagulation nuclei formed by components of the dolomite grow;
a CAP system for adsorbing the flocs, grown by the source water supplied from the slow mixing tank, to a coil-type filter so that treated water is separated therefrom;
an inorganic coagulant injecting device for supplying the inorganic coagulant to the rapid mixing tank; and
a dolomite injecting device for supplying the dolomite to the rapid mixing tank.

4. The apparatus for phosphorous removal using dolomite according to claim 1, wherein the dolomite plays a role of an alkaline chemical to raise pH of the source water, which has been lowered by the inorganic coagulant, so that the source water is neutralized.

5. The apparatus for phosphorous removal using dolomite according to claim 2, wherein the dolomite plays a role of an alkaline chemical to raise pH of the source water, which has been lowered by the inorganic coagulant, so that the source water is neutralized.

6. The apparatus for phosphorous removal using dolomite according to claim 3, wherein the dolomite plays a role of an alkaline chemical to raise pH of the source water, which has been lowered by the inorganic coagulant, so that the source water is neutralized.

7. The apparatus for phosphorous removal using dolomite according to claim 1, wherein the dolomite is fired at a temperature of 800 to 900° C. so that CO₂ components are removed.

8. The apparatus for phosphorous removal using dolomite according to claim 2, wherein the dolomite is fired at a temperature of 800 to 900° C. so that CO₂ components are removed.

9. The apparatus for phosphorous removal using dolomite according to claim 3, wherein the dolomite is fired at a temperature of 800 to 900° C. so that CO₂ components are removed.

10. The apparatus for phosphorous removal using dolomite according to claim 1,
wherein the inorganic coagulant is a low basicity inorganic coagulant or a high basicity inorganic coagulant,
wherein the low basicity inorganic coagulant is any one selected from the group consisting of aluminum sulfate, ferric chloride, ferric aluminum, and magnesium chloride, and
wherein the high basicity inorganic coagulant is any one selected from the group consisting of polyaluminum chloride, polyaluminum chloride silicate, polyaluminum hydroxy chloro sulfate, polyaluminum chloride silicate, polyaluminum chloride sulfate silicate, and polyaluminum sulfate silicate.

11. The apparatus for phosphorous removal using dolomite according to claim 2,
wherein the inorganic coagulant is a low basicity inorganic coagulant or a high basicity inorganic coagulant,
wherein the low basicity inorganic coagulant is any one selected from the group consisting of aluminum sulfate, ferric chloride, ferric aluminum, and magnesium chloride, and
wherein the high basicity inorganic coagulant is any one selected from the group consisting of polyaluminum chloride, polyaluminum chloride silicate, polyaluminum hydroxy chloro sulfate, polyaluminum chloride silicate, polyaluminum chloride sulfate silicate, and polyaluminum sulfate silicate.

12. The apparatus for phosphorous removal using dolomite according to claim 3,
wherein the inorganic coagulant is a low basicity inorganic coagulant or a high basicity inorganic coagulant,
wherein the low basicity inorganic coagulant is any one selected from the group consisting of aluminum sulfate, ferric chloride, ferric aluminum, and magnesium chloride, and
wherein the high basicity inorganic coagulant is any one selected from the group consisting of polyaluminum chloride, polyaluminum chloride silicate, polyaluminum hydroxy chloro sulfate, polyaluminum chloride silicate, polyaluminum chloride sulfate silicate, and polyaluminum sulfate silicate.

13. A method for phosphorous removal using dolomite, comprising:
stirring an inorganic coagulant and dolomite together with source water to form flocs by reacting phosphate ions (−) contained in the source water and metal ions (+) of the inorganic coagulant, to form coagulation nuclei composed of Ca and Mg precipitates or Ca, Mg and Fe precipitates of the dolomite, and to allow the dolomite to raise pH of the source water, which has been lowered by the inorganic coagulant, so that the source water is neutralized; and
after the inorganic coagulant, the dolomite, and the source water are stirred, separating treated water therefrom by gravitationally settling the grown flocks or adsorbing the flocks to a filter and removing the flocks.

14. The method for phosphorous removal using dolomite according to claim 13, further comprising: firing the dolomite at a temperature of 800 to 900° C. so that CO₂ components are removed.

15. The method for phosphorous removal using dolomite according to claim 13,
wherein the inorganic coagulant is a low basicity inorganic coagulant or a high basicity inorganic coagulant,
wherein the low basicity inorganic coagulant is any one selected from the group consisting of aluminum sulfate, ferric chloride, ferric aluminum, and magnesium chloride, and
wherein the high basicity inorganic coagulant is any one selected from the group consisting of polyaluminum chloride, polyaluminum chloride silicate, polyaluminum hydroxy chloro sulfate, polyaluminum chloride silicate, polyaluminum chloride sulfate silicate, and polyaluminum sulfate silicate.
